(19) United States
(12) Patent Application Publication
(10) Pub. No.: US 2020/0007980 A1
(43) Pub. Date: Jan. 2, 2020

(54) SPEAKER STRUCTURAL LAYER AND DISPLAY DEVICE

(71) Applicant: Au Optronics Corporation, Hsinchu (TW)

(72) Inventors: Chih-Ling Hsueh, Hsinchu (TW); Li-Chih Hsu, Taipei City (TW); Jian-Shuen Fang, Hsinchu (TW)

(73) Assignee: Au Optronics Corporation, Hsinchu (TW)

(21) Appl. No.: 16/403,627

(22) Filed: May 6, 2019

(30) Foreign Application Priority Data
Jun. 29, 2018 (TW) 107122427

(51) Int. Cl. H04R 1/40; H04R 1/02; H04R 17/00; H04R 19/02

(52) U.S. Cl. CPC H04R 1/403; H04R 1/028; H04R 2400/11; H04R 19/02; H04R 2499/15; H04R 17/00

(57) ABSTRACT

A speaker structural layer includes speaker units arranged in array. At least one of the speaker units includes a first electrode, a second electrode and a diaphragm. The second electrode is opposite to the first electrode. The diaphragm is disposed between the first electrode and the second electrode.

### CROSS REFERENCE TO RELATED APPLICATION

This application claims the priority benefit of Taiwan application serial no. 107122427, filed on Jun. 29, 2018. The entirety of the above-mentioned patent application is hereby incorporated by reference herein and made a part of specification.

### BACKGROUND OF THE INVENTION

### 1. Field of the Invention

The invention relates to a speaker structural layer and a display device, and particularly relates to a speaker structural layer and a display device capable of locally producing sounds.

### 2. Description of Related Art

Traditionally, for a speaker placed on the ground or on a desk, a sound producing driver is disposed inside a cabinet. However, since the size of the cabinet is generally larger, such the cabinet may occupy an excessively large space when being stored. Therefore, in recent years, speakers are disposed in a display device. For example, a speaker may be disposed on the periphery or at the back side of a display panel of the display device. However, the output sounds lack a feeling of presence if the speaker is disposed at the back side or on the periphery of the display panel of the display device. Besides, disposing the speaker on the periphery of the display panel of the display device rules out the possibility of realizing a frameless or slim boarder design in the display panel of the display device.

### SUMMARY OF THE INVENTION

The embodiment of the invention provides a speaker structural layer. When the speaker structural layer is applied to a display device, the output sounds may offer a feeling of presence, and a frameless design is applicable to the display device.

The embodiment of the invention provides a display device not only capable of outputting sounds with a feeling of presence but also applicable for a frameless or slim boarder design.

An embodiment of the invention provides a speaker structural layer including a plurality of speaker units arranged in array. At least one of the speaker units includes a first electrode, a second electrode and a diaphragm. The second electrode is opposite to the first electrode. The diaphragm is disposed between the first electrode and the second electrode.

A display device according to an embodiment of the invention includes a display panel and the aforementioned speaker structural layer. The display panel includes a pixel array substrate, an opposite substrate, and a display medium layer. The display medium layer is located between the pixel array substrate and the opposite substrate, and the pixel array substrate comprises a plurality of pixel units. The speaker structural layer is disposed at at least one side of the display panel. The respective speaker units correspond to the respective pixel units, or at least one of the speaker units corresponds to the pixel units.

A display device according to an embodiment of the invention includes a display panel and a plurality of actuators. The display panel has a display surface and a back surface opposite to each other. The actuators are arranged into a multi-dimensional array on the back surface of the display panel.

Based on the above, since the speaker structural layer according to the embodiments of the invention includes the speaker units arranged in array and each of the speaker units includes the first electrode, the second electrode, and the diaphragm disposed between the first electrode and the second electrode, when the display device according to the embodiments of the invention includes the speaker structural layer located at a side of the display panel, there is no need to consider disposing a speaker structure on the periphery of the display panel, such that the display device is applicable for a frameless or slim boarder design; and also the display device with the speaker structural layer is able to output a sound through the corresponding speaker unit according to a display image, such that the effect of producing sounds locally is achieved, and the feeling of presence experienced with the output sound is more favorable. Besides, in another display device according to the embodiments of the invention, the actuators in a multi-dimensional array are disposed on the back surface of the display panel. In this way, there is no need to consider disposing a speaker structure on the periphery of the display panel for the display device, such that a frameless or slim boarder design can be realized; and the display device allows a sound to be produced through the corresponding actuator according to a display image, such that the effect of producing sounds locally can be achieved, and the feeling of presence experienced with the output sound is more favorable.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic top view illustrating a speaker structural layer according to an embodiment of the invention.

FIG. 1B is a schematic cross-sectional view taken along a cross-sectional line A-A′ of FIG. 1A.

Each of FIGS. 2A to 2E is a schematic top view illustrating a speaker unit according to other embodiments of the invention.

FIG. 3A is a schematic top view illustrating a speaker structural layer according to another embodiment of the invention.

FIG. 3B is a schematic cross-sectional view taken along a cross-sectional line B-B′ of FIG. 3A.

FIG. 4A is a schematic top view illustrating a speaker structural layer according to another embodiment of the invention.

FIG. 4B is a schematic cross-sectional view taken along a cross-sectional line C-C′ of FIG. 4A.

FIG. 5A is a schematic exploded view illustrating a display device according to an embodiment of the invention.

FIG. 5B is a schematic exploded view illustrating a display device according to another embodiment of the invention.

FIG. 6A is a schematic three-dimensional rear view illustrating a display device according to another embodiment of the invention.

FIG. 6B is a schematic top view illustrating an actuator of FIG. 6A.

FIG. 6C is a schematic cross-sectional view taken along a cross-sectional line D-D′ of FIG. 6B.

FIG. 7A is a schematic top view illustrating an actuator according to another embodiment of the invention.

FIG. 7B is a schematic cross-sectional view taken along a cross-sectional line E-E′ of FIG. 7A.

### DESCRIPTION OF THE EMBODIMENTS

The invention now will be described more fully hereinafter with reference to the accompanying drawings, in which exemplary embodiments of the invention are shown. As appreciated by those of ordinary skill in the art, various different modifications can be made to the embodiments described hereinafter without departing from the spirit or scope of the invention.

Unless otherwise defined, all of the terms (including technical and scientific terms) used herein have the same meaning as commonly understood by those of ordinary skills in the art to which the invention belongs. It will be further understood that the terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the invention are described with reference of schematic cross-sectional views of the idealized embodiments. Therefore, a shape variation of the drawings as a result of a manufacturing technique and/or manufacturing tolerance, for example, is expected. Therefore, the embodiments of the invention should not be interpreted as being limited to specific shapes of the regions shown in the drawings but may include a shape deviation caused during manufacture, for example. For example, a flat area shown in the figures or described herein may practically have rough and/or non-linear characteristics. Moreover, an acute angle shown in the drawings can practically be rounded. Therefore, the shapes shown in the figures are substantially schematic, and the shapes therein are not intended to represent accurate shapes, and are not intended to serve as limitations of the claims.

In the accompanying drawings, for the purpose of clarity, the thicknesses of layers, films, panels, regions, etc. are enlarged. Throughout the specification, like symbols of the accompanying drawings represent like components. It should be understood that, when a component of a layer, a film, a region, or a substrate is described as being “on” or “connected to” another component, such a component may be directly on or connected to the another component, or an intermediate component may be present. On the contrary, when a component is described as being “directly on another component” or “directly connected to another component”, the intermediate component is not present. As described herein, the term “connect” may refer to physical and/or electrical connection. Also, terms such as “electrically connect” or “couple” may suggest presence of another component between two components.

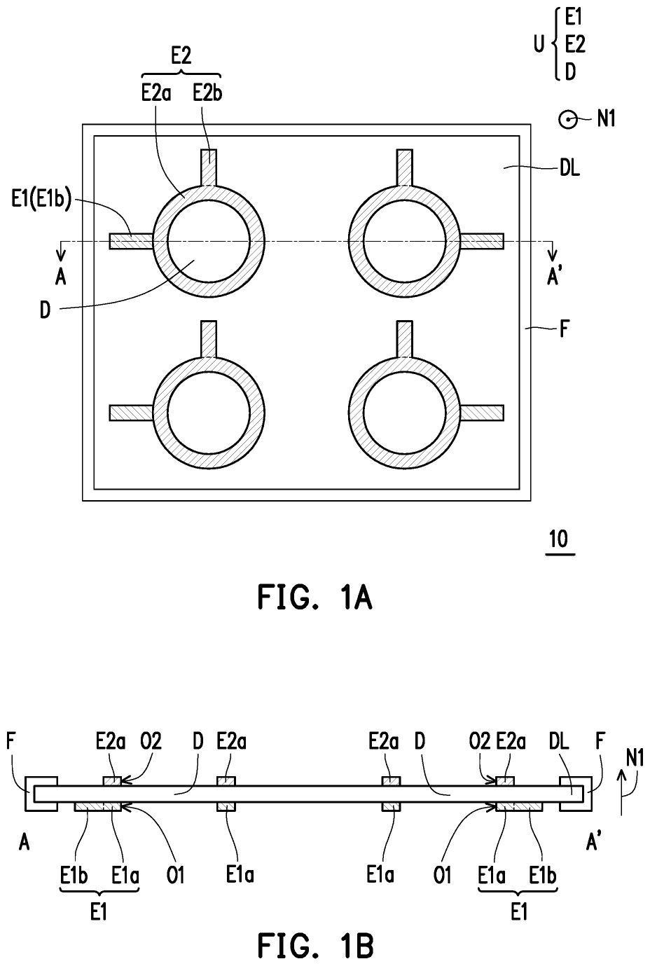

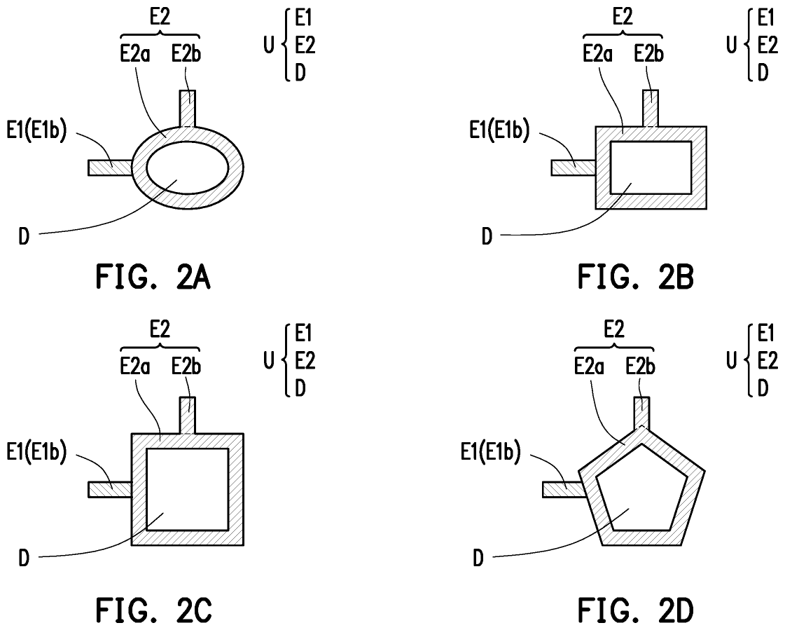

FIG. 1A is a schematic top view illustrating a speaker structural layer according to an embodiment of the invention. FIG. 1B is a schematic cross-sectional view taken along a cross-sectional line A-A′ of FIG. 1A.

Referring to FIGS. 1A and 1B, a speaker structural layer 10 includes a plurality of speaker units U arranged in array. The speaker structural layer 10 shown in FIG. 1A includes four speaker units U arranged in array as an example. However, the invention is not limited thereto. In other embodiments, those applying the embodiment may adjust the numbers of columns and rows of the array (i.e., the number of the speaker units U) according to their design needs, and the configuration still falls into the scope of the invention as long as the speaker structural layer 10 includes multiple speaker units U arranged in array. In the embodiment, the speaker structural layer 10 may optionally include a frame F.

In the embodiment, as shown in FIG. 1A, each of the speaker units U includes a first electrode E1, a second electrode E2, and a diaphragm D. The diaphragm D is disposed between the first electrode E1 and the second electrode E2. For example, in the embodiment, the first electrode E1 and the second electrode E2 are respectively in direct contact with the diaphragm D. However, the invention is not limited thereto. In other embodiments, the first electrode E1 and the second electrode E2 may be respectively in indirect contact with the diaphragm D, as long as the first electrode E1 and the second electrode E2 are able to make the diaphragm D vibrate. In the embodiment, the speaker units U may be electrostatic thin-film speaker units or piezoelectric speaker units.

In the embodiment, the second electrode E2 is disposed opposite to the first electrode E1. In other words, in the embodiment, the second electrode E2 and the first electrode E1 are respectively located at two opposite sides of the diaphragm D. In the embodiment, the materials of the first electrode E1 and the second electrode E2 may respectively include: metal materials, metal oxides, conductive polymer materials, or other suitable materials. The conductive polymer materials include, for example, polythiophene (PT) or other suitable polymer materials, the metal materials include, for example, copper, steel, copper tungsten alloy, copper silver alloy, or other suitable metals, and the metal oxides include, for example, indium tin oxide, indium zinc oxide, aluminum tin oxide, aluminum zinc oxide, indium gallium zinc oxide, other suitable metal oxides, or a stacked layer of at least two of the above.

In the embodiment, the first electrode E1 has a main body part E1a and a connection part E1b connected to each other, and the second electrode E2 has a main body part E2a and a connection part E2b connected to each other. For example, in the embodiment, the connection part E1b of the first electrode E1 and the connection part E2b of the second electrode E2 may be respectively electrically connected to an external circuit (not shown) to drive the speaker units U. In an embodiment, the external circuit (not shown) may be, for example, a plurality of power sources respectively independent from each other or a common power source. In the embodiment, a voltage difference between the first electrode E1 and the second electrode E2 rendered through the external circuit (not shown) induces oscillation waves, and the oscillation waves drive the diaphragm D to vibrate and produce a sound.

In the embodiment, the shapes of the main body part E1a of the first electrode E1 and the main body part E2a of the second electrode E2 are respectively a round shape or a shape similar to a round shape. However, the invention is not limited thereto. In other embodiments, the shapes of the main body part E1a of the first electrode E1 and the main body part E2a of the second electrode E2 may respectively be similar to an elliptical shape (as shown in FIG. 2A), a rectangular shape (as shown in FIG. 2B), a square shape (as shown in FIG. 2C), or a polygonal shape (as shown in FIG. 2D). In an embodiment, the shapes of the main body part E1a of the first electrode E1 and the main body part E2a of the second electrode E2 are substantially a round shape. When the shapes of the main body part E1a of the first electrode E1 and the main body part E2a of the second electrode E2 are substantially a round shape, the oscillation waves induced by the voltage difference between the first electrode E1 and the second electrode E2 can be transmitted more uniformly, and the effect of sounds produced is more favorable. Besides, the speaker structural layer 10 shown in FIG. 1A includes the speaker units U whose main profiles are all substantially round. However, the invention is not limited thereto. In other embodiments, the speaker structural layer 10 may also include the speaker units U whose main profiles have at least two or more shapes. For example, in an embodiment, the shapes of the main body parts E1a of the first electrodes E1 and the shapes of the main body parts E2a of the second electrodes E2 in some of the speaker units U are substantially a round shape, while the shapes of the main body parts E1a of the first electrodes E1 and the shapes of the main body parts E2a of the second electrodes E2 in some other of the speaker units U are substantially a square shape.

In the embodiment, the main body part E1a of the first electrode E1 and the main body part E2a of the second electrode E2 are overlapped with each other in a normal direction N1 of the diaphragm D. FIG. 1A shows that the main body part E1a of the first electrode E1 and the main body part E2a of the second electrode E2 are completely overlapped in the normal direction N1 of the diaphragm D. However, the invention is not limited thereto. In other embodiments, the main body part E1a of the first electrode E1 and the main body part E2a of the second electrode E2 may also be partially overlapped in the normal direction N1.

In the embodiment, the first electrode E1 and the second electrode E2 respectively have an opening O1 and an opening O2. For example, in the embodiment, the opening O1 is located in the main body part E1a of the first electrode E1 and the opening O2 is located in the main body part E2a of the second electrode E2. Even though FIG. 1A illustrates that the first electrode E1 and the second electrode E2 respectively have the openings O1 and O2, the invention is not limited thereto. In other embodiments, at least one of the first electrode E1 and the second electrode E2 may have no opening. In the embodiment, with the first electrode E1 and the second electrode E2 respectively having the openings O1 and O2, when the speaker structural layer 10 is applied to a display device (e.g., a display device 1000 or a display device 2000 to be described subsequently) and disposed to a display side (e.g., a display side 100a to be described subsequently) of a display panel (e.g., a display panel 100 to be described subsequently), the influence of the speaker structural layer 10 on the display quality can be reduced, particularly in embodiments where the materials of the first electrode E1 and the second electrode E2 are opaque materials (e.g., metal materials).

In the embodiment, as shown in FIG. 1A, the shapes of the main body part E1a of the first electrode E1 and the main body part E2a of the second electrode E2 are enclosed ring shapes. However, the invention is not limited thereto. In other embodiments, the shape of the main body part E1a of the first electrode E1 or the shape of the main body part E2a of the second electrode E2 may also be a non-enclosed ring shape, as shown in FIG. 2E. Specifically, in FIG. 2E, the shape of the main body part E1a of the first electrode E1 is the enclosed ring shape, and the shape of the main body part E2a of the second electrode E2 is the non-enclosed ring shape. In other words, the shape of the main body part E2a of the second electrode E2 is similar to a C shape, and the opening O2 of the second electrode E2 is not completely surrounded by the main body part E2a, while the opening O1 of the first electrode E1 is completely surrounded by the main body part E1a.

In the embodiment, the material of the diaphragm D may be a polymer thin film material or a piezoelectric material, such as including polydimethylsiloxane (PDMS), polyvinylidene difluoride (PVDF), a composite lead zirconate titanate (composite PZT) ceramic material, a nanometer/micrometer-scale porous electret material, other suitable materials, or a combination thereof. In the embodiment, as shown in FIGS. 1A and 1B, the diaphragms D of the speaker units U are connected to each other to form a diaphragm layer DL. In other words, in the embodiment, the part of the diaphragm layer DL corresponding to the first electrodes E1 and the second electrodes E2 serve as the diaphragms D of the speaker units U.

In the embodiment, the frame F serves to support the diaphragm layer DL to reinforce the structural strength of the speaker structural layer 10. In the embodiment, the frame F is disposed to the periphery of the diaphragm layer DL, and the diaphragm layer DL is embedded into the frame F. In other words, the frame F encapsulates the edge of the diaphragm layer DL. Even though FIG. 1A illustrates that the frame F is disposed to the four sides of the diaphragm layer DL, the invention is not limited thereto. In other embodiments, the frame F may also be disposed only to two opposite sides or three sides of the diaphragm layer DL.

Since the speaker structural layer 10 includes the speaker units U arranged in array and each of the speaker units U includes the first electrode E1 and the second electrode E2 disposed to be opposite to each other and the diaphragm D disposed between the first electrode E1 and the second electrode E2, the speaker structural layer 10 is able to output a sound through the corresponding speaker unit U according to a display image when the speaker structural layer 10 is applied to a display device (e.g., the display device 1000 or the display device 2000 to be described subsequently). In this way, the effect of producing sounds locally is achieved, and the feeling of presence experienced with the output sound is more favorable.

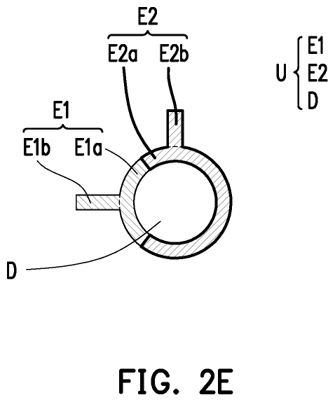

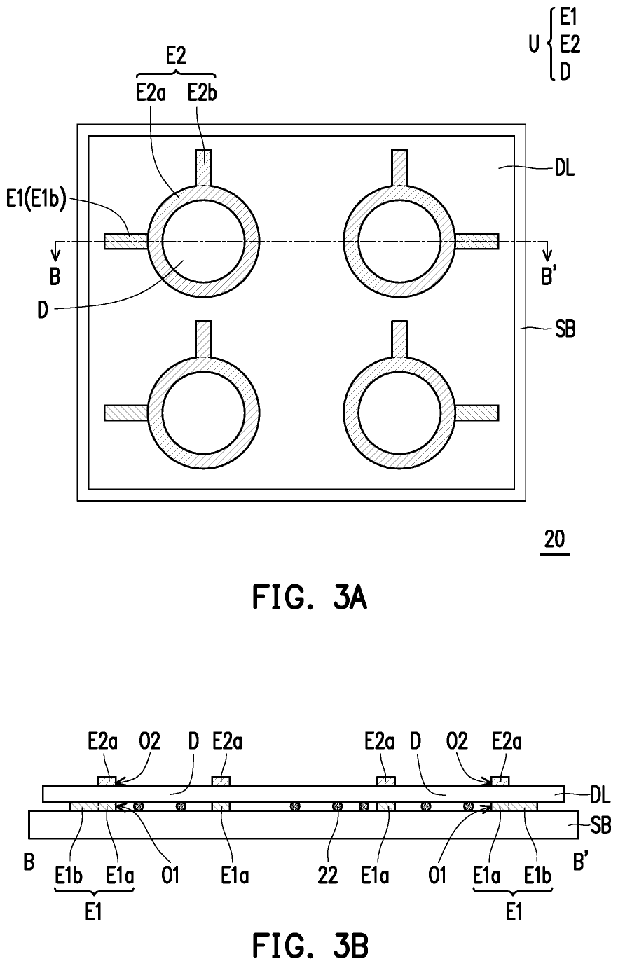

FIG. 3A is a schematic top view illustrating a speaker structural layer according to another embodiment of the invention. FIG. 3B is a schematic cross-sectional view taken along a cross-sectional line B-B′ of FIG. 3A. Referring to FIGS. 3A and 1A, a speaker structural layer 20 of FIG. 3A is similar to the speaker structural layer 10 of FIG. 1A. Therefore, like or similar components are referred to with like or similar symbols, and the descriptions of the same technical contents are omitted. For a detailed description of the omitted parts, reference can be found in the previous embodiment, and no repeated description is contained in the following embodiments. In the following, the difference between the speaker structural layer 20 of FIG. 3A and the speaker structural layer 10 of FIG. 1A is described.

Referring to FIGS. 3A and 3B, the speaker structural layer 20 includes a carrier substrate SB. In the embodiment, the speaker structural layer 20 may optionally include a support structure 22. However, the invention is not limited thereto. In other embodiment, the speaker structural layer 20 may include no support structure 22.

In the embodiment, the carrier substrate SB is disposed below the speaker units U. For example, the carrier substrate SB serves to carry the speaker units U to reinforce the structural strength of the speaker structural layer 20. From another perspective, in the embodiment of FIGS. 1A and 1B, the structural strength of the speaker structural layer 10 is established with the frame F at least disposed at two opposing sides of the diaphragm layer DL, while in the embodiment, the structural strength of the speaker structural layer 20 is established with the carrier substrate SB. In the embodiment, the material of the carrier substrate SB may be glass, quartz, an organic polymer, metal, or other suitable materials.

In the embodiment, the first electrode E1 is located between the carrier substrate SB and the diaphragm layer DL. From another perspective, the first electrode E1 and the carrier substrate SB may be in direct contact. Even though FIGS. 3A and 3B show that the diaphragm layer DL formed by connecting the diaphragms D of the four speaker units U with each other is located on the carrier substrate SB, the invention is not limited thereto. In other embodiments, the diaphragm layer DL may be formed by connecting the diaphragms D of two, three, or five or more speaker units U with each other. For example, in the case where the speaker structural layer 20 has four speaker units U, one or two sheets of the diaphragm layers DL may be disposed on the carrier substrate SB. In other words, based on the number of the speaker units U included in the speaker structural layer 20, the speaker structural layer 20 may include one or more diaphragm layers DL, and each diaphragm layer DL needs to correspond to two or more speaker units U.

In the embodiment, the support structure 22 is disposed on the carrier substrate SB and located between the carrier substrate SB and the diaphragm layer DL. The support structure 22 may also be located between the carrier substrate SB and the diaphragms D and/or between the carrier substrate SB and the part of the diaphragm layer DL excluding the diaphragms D. The support structure 22 serves to support the diaphragm layer DL to prevent the diaphragm layer DL from collapsing and affecting outputting of sounds. The support structure 22 is, for example, a spacer, a buffer layer, or other suitable structures with a supporting capability.

Since the speaker structural layer 20 includes the speaker units U arranged in array and each of the speaker units U includes the first electrode E1 and the second electrode E2 disposed to be opposite to each other and the diaphragm D disposed between the first electrode E1 and the second electrode E2, the speaker structural layer 20 is able to output a sound through the corresponding speaker unit U according to a display image when the speaker structural layer 20 is applied to a display device (e.g., the display device 1000 or the display device 2000 to be described subsequently). In this way, sounds can be produced locally, and the feeling of presence experienced with the output sound is more favorable.

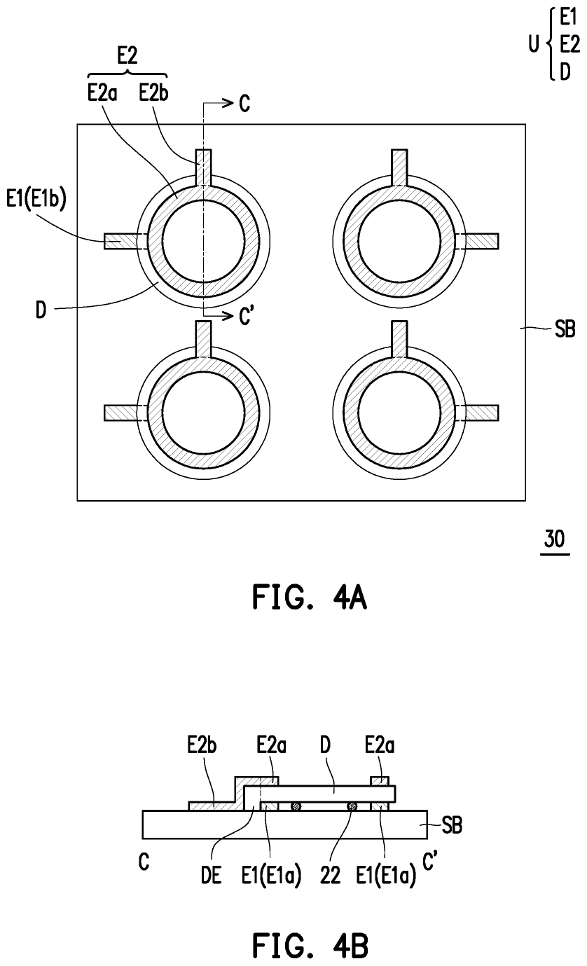

FIG. 4A is a schematic top view illustrating a speaker structural layer according to another embodiment of the invention. FIG. 4B is a schematic cross-sectional view taken along a cross-sectional line C-C′ of FIG. 4A. Referring to FIGS. 4A and 3A, a speaker structural layer 30 of FIG. 4A is similar to the speaker structural layer 20 of FIG. 3A. Therefore, like or similar components are referred to with like or similar symbols, and the descriptions of the same technical contents are omitted. For a detailed description of the omitted parts, reference can be found in the previous embodiment, and no repeated description is contained in the following embodiments. In the following, the difference between the speaker structural layer 30 of FIG. 4A and the speaker structural layer 20 of FIG. 3A is described.

Referring to FIGS. 4A and 4B, in a speaker structural layer 30, the diaphragms D of the speaker units U are disposed separately from each other. In other words, the diaphragms D of the four speaker units U shown in FIG. 4A are not connected with each other. As shown in FIG. 4B, the diaphragm D has an extension part DE in contact with the carrier substrate SB. For example, as shown in FIG. 4B, the extension part DE extends along a surface of the main body part E1a of the first electrode E1 to contact the carrier substrate SB. Besides, in the speaker structural layer 30, the support structure 22 is only disposed between the carrier substrate SB and the diaphragm D.

In the embodiment, the connection part E2b of the second electrode E2 is in contact with the carrier substrate SB. For example, the connection part E2b covers a surface of the extension part DE of the diaphragm D to contact the carrier substrate SB. From another perspective, in the embodiment, the extension part DE of the diaphragm D is located between the connection part E2b of the second electrode E2 and the main body part E1a of the first electrode E1. In this way, the connection part E2b of the second electrode E2 is able to avoid an issue of short-circuiting resulting from direct contact with the main body part E1a of the first electrode E1.

With the speaker units U of the speaker structural layer 30 arranged in array and each of the speaker units U including the first electrode E1 and the second electrode E2 disposed to be opposite to each other and the diaphragm D disposed between the first electrode E1 and the second electrode E2, the speaker structural layer 30 is able to output a sound through the corresponding speaker unit U according to a display image when the speaker structural layer 30 is applied to a display device (e.g., the display device 1000 or the display device 2000 to be described subsequently). In this way, sounds can be produced locally, and the feeling of presence experienced with the output sound is more favorable.

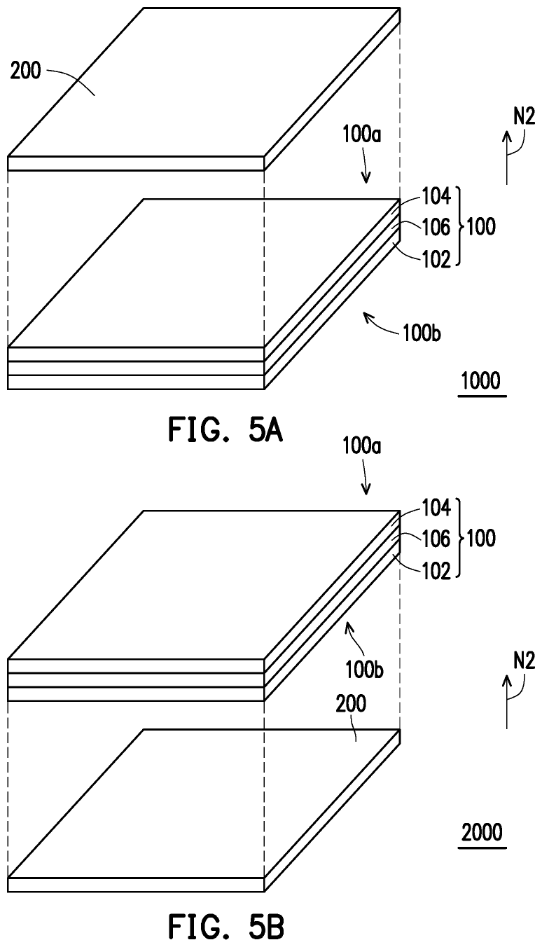

As described above, the speaker structural layers 10 to 30 can be applied to a display device, so that the speaker structural layer 10 to 30 are able to output a sound through the corresponding speaker unit U according to a display image. In the following, a display device including the speaker structural layer is described with reference to FIGS. 5A and 5B.

FIG. 5A is a schematic exploded view illustrating a display device according to an embodiment of the invention.

Referring to FIG. 5A, in the embodiment, the display device 1000 includes the display panel 100 and a speaker structural layer 200. In the embodiment, the display panel 100 has the display side 100a and a back side 100b opposite to each other. Here, the display side 100a is defined to be at a user viewable position. In the embodiment, the display panel 100 may be a self-luminescent display panel, such as an organic light emitting display panel, an inorganic light emitting display panel. In the embodiment, the display panel 100 includes a pixel array substrate 102, an opposite substrate 104, and a display medium layer 106.

In the embodiment, the back side 100b of the display panel 100 is located on an exterior surface of the pixel array substrate 102, but the invention is not limited thereto. The pixel array substrate 102 may be any pixel array substrate applicable to a self-luminescent display panel known by people having ordinary skill in the art. The pixel array substrate 102 includes a plurality of pixel units (not shown). For example, in an embodiment, the pixel array substrate 102 may include a substrate and a device layer located on the substrate. In an embodiment, the substrate is, for example, a rigid substrate or a flexible substrate. The material of the rigid substrate includes, for example, glass, quartz, an organic polymer, or other suitable materials, whereas the material of the flexible substrate includes, for example, polyimide (PI), polyethylene naphthalate (PEN), polyethylene terephthalate (PET), polycarbonate (PC), poly(ether sulfone) (PES), polyarylate, or other suitable materials. In an embodiment, the device layer included in the pixel array substrate 102 is, for example, an active device array layer, which may include, for example, a plurality of scan lines, a plurality of data lines, a plurality of transistors, a plurality of electrodes, a plurality of capacitors, and at least one insulating layer. However, the invention is not limited thereto, and various modifications and changes can be made based on needs.

The opposite substrate 104 is disposed opposite to the pixel array substrate 102. In addition, people having ordinary skills in the art may optionally dispose the opposite substrate 104 based on needs. The opposite substrate 104 may be any opposite substrate applicable to a self-luminescent display panel known by people having ordinary skills in the art. For example, in an embodiment, the opposite substrate 110 may include another substrate and another device layer located on the another substrate. In an embodiment, the another substrate is, for example, a rigid substrate or a flexible substrate. The material of the rigid substrate includes, for example, glass, quartz, an organic polymer, or other suitable materials, whereas the material of the flexible substrate includes, for example, polyimide, polyethylene naphthalate, polyethylene terephthalate, polycarbonate, poly(ether sulfone), polyarylate, or other suitable materials. In an embodiment, the another device layer included in the opposite substrate 110 may include, for example, a color filter layer, a wavelength conversion layer, a shielding pattern layer, or a combination thereof. However, the invention is not limited thereto, and various modifications and changes can be made based on needs.

In an embodiment, the display medium layer 106 is located between the pixel array substrate 102 and the opposite substrate 104. From another perspective, the display medium layer 160 may be optionally located at a side of the pixel array substrate 102 or a side of the opposite substrate 104. The display medium layer 106 may be any display medium applicable to a self-luminescent display panel known by people having ordinary skills in the art, such as an organic light emitting diode material, an inorganic light emitting diode material, or other suitable self-luminescent materials.

In the embodiment, the speaker structural layer 200 may be realized with the speaker structural layer 10 of FIGS. 1A and 1B, the speaker structural layer 20 of FIGS. 2A and 2B, or the speaker structural layer 30 of FIGS. 3A and 3B. In the embodiment, the speaker structural layer 200 is disposed at the display side 100a of the display panel 100. In other words, the speaker structural layer 200 is disposed at a side of the display panel 100. While FIG. 5A shows that the speaker structural layer 200 and the display panel 100 are completely overlapped in a normal direction N2 of the display panel 100, the invention is not limited thereto. In other embodiments, the speaker structural layer 200 may be completely overlapped with only a display image region of the display panel 100 in the normal direction N2. Besides, the speaker structural layer 200 may be attached to the display side 100a of the display panel 100 through adhesion, static electricity, or the like. However, the invention is not limited thereto. In other embodiments, the speaker structural layer 200 may be externally assembled to the display side 100a of the display panel 100.

Since the display device 1000 includes the display panel 100 and the speaker structural layer 200, and the speaker structural layer 200 is disposed at a side of the display panel 100, there is no need to consider disposing a speaker structure on the periphery of the display panel 100 for the display device 1000,such that a frameless or slim boarder design can be realized, and also the display device 1000 is able to output a sound through the corresponding speaker unit U according to a display image, so the effect of producing sounds locally can be achieved, and the feeling of presence experienced with the output sound is more favorable.

Besides, in the embodiment of FIG. 5A, even though the display panel 100 is described with an example of a self-luminescent display panel, the invention is not limited thereto. In other embodiments, the display panel 100 may also be a non-self-luminescent display panel, such as a liquid crystal display panel, an electro-wetting display panel, an electrochromic display panel, an electric dust display panel, an electrophoresis display panel, or other suitable non-self-luminescent display panels. At this time, the pixel array substrate 102, the opposite substrate 104, and the display medium layer 106 of the non-self-luminescent display panel may be any pixel array substrate, any opposite substrate, and any display medium applicable to a non-self-luminescent display panel known by people having ordinary skills in the art, and the pixel array substrate 102 includes a plurality of pixel units (not shown). For example, the device layer located on the substrate in the pixel array substrate 102 may be an active device array layer, and may include, for example, a plurality of scan lines, a plurality of data lines, a plurality of transistors, a plurality of electrodes, a plurality of capacitors, and at least one insulating layer, and the device layer located on the another substrate in the opposite substrate 104 may include a color filter layer, a wavelength conversion layer, a shielding pattern layer, an opposite electrode layer, or a combination layer thereof. However, the invention is not limited thereto, and various modifications and changes can be made based on needs. The material of the display medium layer 106 is, for example, a liquid crystal material, an electrophoresis material, an electro-wetting material, an electrochromic material, an electric dust material, or other suitable materials. Moreover, when necessary, a backlight module (not shown) located at the back side 100b of the display panel 100 needs to be disposed to the display 1000. Besides, a single one of the speaker units U may correspond to a single pixel unit, or a single one of the speaker units U may correspond to multiple pixel units.

FIG. 5B is a schematic exploded view illustrating a display device according to another embodiment of the invention. Referring to FIGS. 5B and 5A, a display device 2000 of FIG. 5B is similar to the display device 1000 of FIG. 5A. Therefore, like or similar components are referred to with like or similar symbols, and the descriptions of the same technical contents are omitted. For a detailed description of the omitted parts, reference can be found in the previous embodiment, and no repeated description is contained in the following embodiments. In the following, the difference between the display device 2000 of FIG. 5B and the display device 1000 of FIG. 5A is described.

Referring to FIG. 5B, the speaker structural layer 200 is disposed at the back side 100b of the display panel 100. The speaker structural layer 200 may be attached to the back side 100b of the display panel 100 through adhesion, static electricity, or the like. However, the invention is not limited thereto. In other embodiments, the speaker structural layer 200 may be externally assembled to the back side 100b of the display panel 100. Besides, in the case where the display panel 100 is a non-self-luminescent display panel (e.g., a liquid crystal display panel), in an embodiment, the speaker structural layer 200 is disposed at an external side of a backlight module (not shown) located at the back side 100b away from the display panel 100, for example a backlight module (not shown) is disposed between the back side 100b of the display panel 100 and the speaker structural layer 200, to avoid the difficulty in transmitting and outputting the sound produced by the speaker structural layer 200.

Therefore, since the display device 2000 includes the display panel 100 and the speaker structural layer 200, and the speaker structural layer 200 is disposed at a side of the display panel 100, there is no need to consider disposing a speaker structure on the periphery of the display panel 100 for the display device 2000, such that a frameless or slim boarder design can be realized, and also with the speaker structural layer 200, the display device 2000 is able to output a sound through the corresponding speaker unit U according to a display image, so the effect of producing sounds locally can be achieved, and the feeling of presence experienced with the output sound is more favorable.

Besides, as described previously, the display device 1000 includes the speaker structural layer 200 disposed at the display side 100a of the display panel 100, and the display device 2000 includes the speaker structural layer 200 disposed at the back side 100b of the display panel 100. However, people having ordinary skills in the art should understand that a display device may include both of the speaker structural layers respectively disposed at the display side and the back side of the display panel.

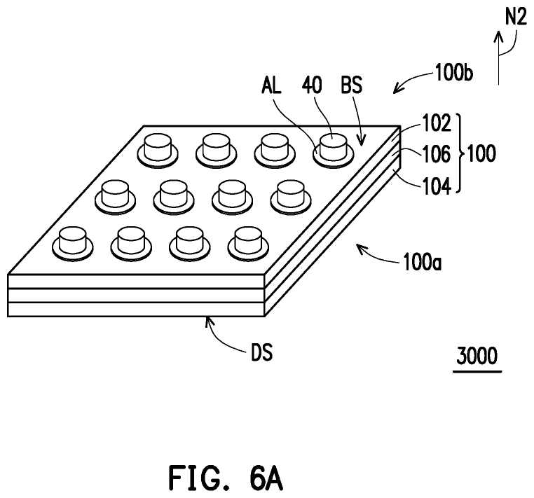

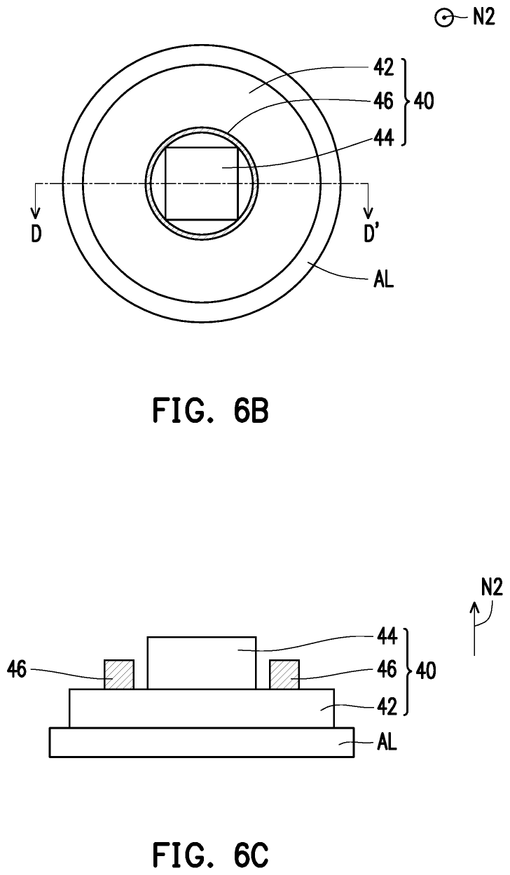

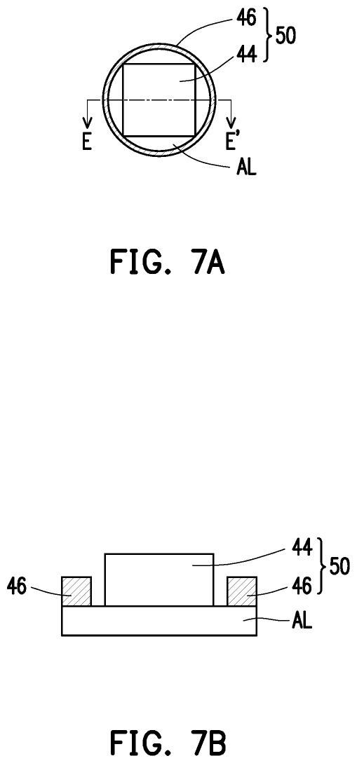

Moreover, in the embodiments of FIGS. 5A and 5B, the display devices 1000 and 2000 output sounds through the speaker structural layer 200. However, the invention is not limited thereto. In the following, other embodiments of the display device are described with reference to FIGS. 6A to 7B.

FIG. 6A is a schematic three-dimensional rear view illustrating a display device according to another embodiment of the invention. FIG. 6B is a schematic top view illustrating an actuator and an adhesive layer of FIG. 6A. FIG. 6C is a schematic cross-sectional view taken along a cross-sectional line D-D′ of FIG. 6B.

Referring to FIGS. 6A and 5B, a display device 3000 of FIG. 6A is similar to the display device 2000 of FIG. 5B. Therefore, like or similar components are referred to with like or similar symbols, and the descriptions of the same technical contents are omitted. For a detailed description of the omitted parts, reference can be found in the previous embodiment, and no repeated description is contained in the following embodiments. In the following, the difference between the display device 3000 of FIG. 6A and the display device 2000 of FIG. 5B is described.

Referring to FIG. 6A, in the embodiment, a display device 3000 includes a plurality of actuators 40 disposed on a back surface BS of the display panel 100. The back surface BS is a surface at the back side 100b of the display panel 100, and the back surface BS and a display surface DS located at the display side 100a are opposite to each other. Besides, in the embodiment, the display device 3000 may optionally further include an adhesive layer AL.

In the embodiment, the actuators 40 are arranged into a multi-dimensional array on the back surface BS. Specifically, as shown in FIG. 6A, the actuators 40 are disposed on the back surface BS by being arranged into a 3×4 array (i.e., multi-dimensional array). However, the invention is not limited thereto. In other embodiments, those applying the embodiment may adjust the numbers of columns and rows (i.e., the number of the actuators 40) in the multi-dimensional array according to the design needs, and the configuration still falls within the scope of the invention as long as the actuators 40 in the multi-dimensional array are disposed on the back surface BS of the display panel 100.

In the embodiment, the actuators 40 are disposed on the back surface BS through the adhesive layer AL. In other words, the adhesive layer AL is disposed between the display panel 100 and the actuators 40. In the embodiment, the material of the adhesive layer AL may be an acrylic-based adhesive, a rubber-based adhesive, a silicone-based adhesive, or other suitable adhesive materials.

Referring to FIGS. 6A, 6B, and 6C, in the embodiment, each of the actuators 40 includes a substrate 42, an actuating unit 44, and a coil 46, and the actuating unit 44 and the coil 46 are disposed on the substrate 42. In the embodiment, the substrate 42 is in direct contact with the adhesive layer AL. In other words, the adhesive layer AL is disposed between the display panel 100 and the substrate 42 of each of the actuators 40. In the embodiment, the material of the substrate 42 may be glass, quartz, an organic polymer, metal, or other suitable materials.

In the embodiment, the substrate 42 includes a control circuit (not shown) for controlling the current flow to the coil 46 so that the coil 46 generates a magnetic effect of current. For example, the coil 46 surrounds the actuating unit 44, so that a magnetic force generated after power is supplied to the coil 46 results in a movement (i.e., vibration) of the actuating unit 44 in the normal direction N2 of the display panel 100. In the display device 3000 of the embodiment, the effect of outputting a sound is achieved by pushing the display panel 100 through vibration of the actuating unit 44 in the normal direction N2 driven by the coil 46. In the embodiment, the material of the actuating unit 44 may be a magnet or other suitable magnetic materials. In the embodiment, the material of the coil 46 may be a conductive material, such as copper or aluminum. However, the invention is not limited thereto.

In the display device 3000, the actuators 40, which allow sounds to be produced, are arranged in a multi-dimensional array on the back surface BS of the display pane. In this way, there is no need to consider disposing a speaker structure on the periphery of the display panel 100 for the display device 3000, so that a frameless or slim boarder design can be realized, and also the display device 3000 allows a sound to be produced through the corresponding actuator 40 according to a display image, so the effect of producing sounds locally can be achieved, and the feeling of presence experienced with the output sound is more favorable.

Besides, in the embodiment of FIGS. 6A to 6C, each of the actuators 40 includes the substrate 42, the actuating unit 44, and the coil 46. However, the invention is not limited thereto. In other embodiments, the substrate 42 of the actuators 40 may be the same one. In other words, the actuators 40 may be located on the same substrate 42. In other embodiments, at least one of the actuators 40 may include no substrate 42. In the following, other embodiments of the actuator are described with reference to FIGS. 7A and 7B.

FIG. 7A is a schematic top view illustrating an actuator and an adhesive layer according to another embodiment of the invention. FIG. 7B is a schematic cross-sectional view taken along a cross-sectional line E-E′ of FIG. 7A. Referring to FIGS. 7A and 6B, an actuator 50 of FIG. 7A is similar to the actuator 40 of FIG. 6B. Therefore, like or similar components are referred to with like or similar symbols, and the descriptions of the same technical contents are omitted. For a detailed description of the omitted parts, reference can be found in the previous embodiment, and no repeated description is contained in the following embodiments. In the following, the difference between the actuator 50 of FIG. 7A and the actuator 40 of FIG. 6B is described.

Referring to FIGS. 6B, 7A, and 7B, the actuator 50 of FIG. 7A differs from the actuator 40 of FIG. 6B in that the actuator 50 of FIG. 7A does not include the substrate 42 of FIG. 6B. In other words, the actuator 50 only includes the actuating unit 44 and the coil 46, and the actuating unit 44 and the coil 46 is in direct contact with the adhesive layer AL. In the embodiment, the adhesive layer AL includes a control circuit (not shown) controlling the current flow to the coil 46. In other words, in the embodiment, the coil 46 is controlled by the control circuit (not shown) located in the adhesive layer AL to generate a magnetic effect of current.

As described above, the display devices 1000 and 2000 output a sound through the speaker structural layer 200, and the display device 3000 outputs a sound through the actuators 40. However, people having ordinary skills in the art should understand that the speaker structural layer and the actuators may be used together in a display device. For example, in an embodiment, the display device may include a display panel, the speaker structural layer, and the actuators, the speaker structural layer is disposed at the display side of the display panel, and the actuators are disposed on the back surface of the display panel.

In view of the foregoing, the display device according to the embodiments of the invention include: the speaker structural layer disposed at a side of the display panel and having the speaker units arranged in array, or the actuators arranged into a multi-dimensional array on the back surface of the display panel. In this way, there is no need to consider disposing a speaker structure on the periphery of the display panel for the display device, so that a frameless or slim boarder design can be realized. Also the display device with the speaker structural layer is able to output a sound through the corresponding speaker unit according to a display image, or the display device is able to allow a sound to be produced through the corresponding actuator according to a display image, so that the effect of producing sounds locally can be achieved, and the feeling of presence experienced with the output sound is more favorable.

It will be apparent to those skilled in the art that various modifications and variations can be made to the structure of the invention without departing from the scope or spirit of the invention. In view of the foregoing, it is intended that the present invention cover modifications and variations of this invention provided they fall within the scope of the following claims and their equivalents.

What is claimed is:

1. A speaker structural layer, comprising:
a plurality of speaker units arranged in array, wherein at least one of the speaker units comprises:
a first electrode;
a second electrode, disposed opposite to the first electrode; and
a diaphragm, disposed between the first electrode and the second electrode.

2. The speaker structural layer as claimed in claim 1, wherein the diaphragms of the speaker units are connected to each other to form a diaphragm layer.

3. The speaker structural layer as claimed in claim 2, further comprising a frame at least disposed to opposite two sides of the diaphragm layer.

4. The speaker structural layer as claimed in claim 2, further comprising a carrier substrate disposed below the speaker units, wherein the first electrodes are located between the diaphragm layer and the carrier substrate.

5. The speaker structural layer as claimed in claim 4, further comprising a support structure disposed on the carrier substrate and located between the carrier substrate and the diaphragm layer.

6. The speaker structural layer as claimed in claim 1, wherein the diaphragms of the speaker units are disposed separately from each other.

7. The speaker structural layer as claimed in claim 6, further comprising a carrier substrate disposed below the speaker units, wherein the first electrodes are located between the diaphragms and the carrier substrate.

8. The speaker structural layer as claimed in claim 7, further comprising a support structure disposed on the carrier substrate and located between the carrier substrate and the diaphragms.

9. The speaker structural layer as claimed in claim 6, wherein in each of the speaker units, the second electrode has a connection part in contact with the carrier substrate, and the diaphragm has an extension part in contact with the carrier substrate, wherein the extension part is located between the connection part and the first electrode.

10. The speaker structural layer as claimed in claim 1, wherein each of the first electrode and the second electrode has a main body part, and shape of the main body part is a circular shape, an elliptical shape, a rectangular shape, a square shape, or a polygonal shape.

11. The speaker structural layer as claimed in claim 1, wherein each of the first electrode and the second electrode has an opening.

12. The speaker structural layer as claimed in claim 1, wherein the speaker units are electrostatic thin-film speaker units or piezoelectric speaker units.

13. A display device, comprising:
a display panel, comprising a pixel array substrate, an opposite substrate, and a display medium layer, wherein the display medium layer is located between the pixel array substrate and the opposite substrate, and the pixel array substrate comprises a plurality of pixel units; and
the speaker structural layer as claimed in claim 1, disposed at at least one side of the display panel, wherein the respective speaker units correspond to the respective pixel units, or at least one of the speaker units corresponds to the pixel units.

14. The display device as claimed in claim 13, wherein the display panel has a display side and a back side opposite to each other, and the speaker structural layer is disposed at the display side.

15. The display device as claimed in claim 13, wherein the display panel has a display side and a back side opposite to each other, and the speaker structural layer is disposed at the back side.

16. A display device, comprising:
a display panel, having a display surface and a back surface opposite to each other; and
a plurality of actuators, arranged into a multi-dimensional array on the back surface of the display panel.

17. The display device as claimed in claim 16, further comprising an adhesive layer disposed between the display panel and the actuators.
